(19) United States
(12) Patent Application Publication
(10) Pub. No.: US 2017/0004943 A1
(43) Pub. Date: Jan. 5, 2017

(54) ACTUATOR FOR A VACUUM SWITCH TUBE OF A SWITCHING ASSEMBLY OF A TAP CHANGER

(71) Applicant: MASCHINENENFABRIK RENHAUSEN GMBH, Regensburg (DE)

(72) Inventors: Klaus HOEPFL, Maxhuette-Haidhof (DE); Stefan HEROLD, Regensburg (DE)

(21) Appl. No.: 15/115,353

(22) PCT Filed: Feb. 18, 2015
(86) PCT No.: PCT/EP2015/053392

§ 371 Date: Jul. 29, 2016

(30) Foreign Application Priority Data
Mar. 5, 2014 (DE) 10 2014 102 875.9

(51) Int. Cl. H01H 33/666; H01H 3/38; H01H 3/04; H01H 9/00

(52) U.S. Cl. CPC H01H 33/666; H01H 9/0038; H01H 3/38; H01H 3/04; H01H 2235/01

(57) ABSTRACT

An actuator (10) for actuating a vacuum switch tube (11) comprising a fixed contact (12) and a movable contact (13), comprises
a bearing plate (14) that can be fastened to the fixed contact (12);
a main spring (15) having a first end (151) with which it can engage the movable contact, and a second end (152);
a return spring (16) having a first end (161) with which it engages at the bearing plate, and a second end (162);
an actuating lever (17) having a first engagement area (171) at which the main spring (15) engages with its second end (152), and having a second engagement area (172) at which the return spring (16) engages with its second end (162);
   wherein
the actuating lever (17) is swivelably mounted on the bearing plate (14) such that the actuating lever (17) can assume a first end position in which the main spring (15) is at least partially relaxed and the return spring (16) is tensioned and in which, in particular, the movable contact (13) is disconnected from the fixed contact (14), and a second end position in which the return spring (16) is at least partially relaxed and the main spring (15) is tensioned and in which, in particular, the movable contact (13) is pressed against the fixed contact (14).

The invention relates to an actuator for actuating a vacuum switch tube, to a switching assembly with such an actuator, as well as to an on-load tap changer with such a switching assembly. The actuator can be, in particular, an actuator for actuating a vacuum switch tube of an on-load tap changer or of a load diverter switch for an on-load tap changer. The switching assembly can be, in particular, a switching assembly for an on-load tap changer of a control transformer or of a transformer with adjustable transmission ratio, or it can be a load diverter switch for an on-load tap changer of a control transformer.

DE 1 917 692 A1 describes a load diverter switch for tapped transformers with four vacuum switches, where in each case two vacuum switches associated with each other are successively connected in the reverse sense, and the switching processes of the two groups, each of two vacuum switches associated with each other, are carried out with a time lag. It is provided that two axially parallel drive shafts each actuate two vacuum switches arranged at both sides of each drive shaft, each via one eccentric arrangement and shift linkages articulated thereon. It is provided that the eccentric arrangement consists of an eccentric and an eccentric ring mounted thereon and pivotally mounted on the shift linkages. It is provided that the shift linkages each consist of two flat bars articulated at the two face sides of the eccentric ring and of an extension rod guided through the bore of a bushing hinged between the flat bars, and supported by an abutment at the one front face of the bushing, which extension rod is axially guided through a guide member fixed to the housing and arranged between the flat bars with its end that projects beyond the abutment, and connected to the switch rod of the vacuum switch with its other end. It is provided that the flat bars are coupled with the extension rod via a compression spring, where the compression spring is supported on the bushing and on a collar of the extension rod.

With this known load diverter switch, the actuation of a vacuum switch requires a complicated mechanism and a large amount of space and components, but due to the heavy strain on the components in this context, it can apply only a limited contact force necessary for pressing together and holding closed the switch contacts of the vacuum switch under current flow.

Known vacuum switch tubes require a contact force of at least 250 N under a rated current of 650 A, for example.

The object of the invention is to enable greater contact forces for an actuator for actuating a vacuum switch tube, for a switching assembly and for an on-load tap changer.

This object is fulfilled by an actuator, a switching assembly and an on-load tap changer according to the independent claims. Advantageous developments and embodiments of the invention are described in the dependent claims.

According to a first aspect of the invention, there is proposed an actuator for actuating a vacuum switch tube comprising a fixed switch contact or fixed contact and a movable switch contact or movable contact, the actuator comprising

a bearing plate that can be fastened to the fixed contact;

a main spring having a first end with which it can engage or abut the movable contact, and a second end;

an additional spring or return spring having a first end with which it engages at or abuts on the bearing plate, and a second end;

an actuating lever having a first engagement point or engagement area that the main spring engages at or abuts on with its second end, and a second engagement point or engagement area that the return spring engages at or abuts on with its second end, and that can be, in particular, coupled to a drive source;

where

the actuating lever is pivotably or swivelably mounted on the bearing plate such that the actuating lever can assume a first end position in which the main spring is at least partially, preferably completely, relaxed and the return spring is tensioned and in which, in particular, the movable contact is disconnected from the fixed contact or in which the actuating lever holds the movable contact disconnected from the fixed contact, and a second end position in which the return spring is at least partially, preferably completely, relaxed and the main spring is tensioned and in which the movable contact is pressed against the fixed contact or in which the actuating lever presses the movable contact against the fixed contact.

Since the forces occurring in the proposed actuator when actuating the vacuum switch tube, in particular when closing and pressing together the contacts, are for the most part absorbed by the bearing plate, the strain on the drive side between the actuating lever and the drive source can be kept low, even in the instance of high contact forces. The proposed actuator can thus apply contact forces that have as yet not been realizable or realizable only with a very high effort and that are far above 250 N, for example at least 1000 N, which corresponds to a rated current of approximately 1300 A, or at least 1350 N, which corresponds to a rated current of approximately 1500 A, or at least 2000 N, which corresponds to a rated current of approximately 1850 A.

The proposed actuator moreover allows very easy and compact installation using only few components and involving little wear.

The proposed actuator can be, in particular, an actuator for actuating a vacuum switch tube of an on-load tap changer, or it can be an actuator for actuating a vacuum switch tube of a load diverter switch for an on-load tap changer.

The proposed actuator can be formed in any manner as required and can comprise or have at least one additional or further main spring and/or at least one additional or further additional spring and/or at least one additional or further actuating lever, for example.

Each spring can be formed in any manner as required, for example as a compression spring or as a tension spring, and/or it can comprise at least one spring coil and/or at least one cylindrical or conical or barrel-shaped torsion spring and/or at least one disk spring, for example.

Each actuating lever can be formed in any manner as required, for example as a straight or angled lever and/or as a one-sided or two-sided lever, and/or it can have at least two lever arms or exactly one lever arm.

Preferably, the bearing of the actuating lever is designed such that the movable contact is disconnected from the fixed contact or the actuating lever holds the movable contact disconnected from the fixed contact in the first end position when the vacuum switch tube is properly installed or inserted into the actuator, and/or the movable contact is pressed against the fixed contact or the actuating lever presses the movable contact against the fixed contact in the second end position.

Alternatively or additionally, the actuating lever can be pivotably or swivelably mounted on the bearing plate such that it can assume an intermediate position in which the return spring is at least partially, preferably completely, relaxed and the main spring is at least partially, preferably completely, relaxed. Preferably, the bearing of the actuating lever is designed such that the movable contact touches the fixed contact pressurelessly or forcelessly or only with its own weight in the intermediate position when the vacuum switch tube is properly installed or inserted into the actuator.

It can be provided that the main spring and the return spring are formed and/or dimensioned and/or arranged such that the actuating lever is biased into the first end position.

It can be provided that the main spring is a compression spring and that its first end abuts on a first contact surface of the movable contact, which first contact surface faces toward the first engagement area.

Preferably, the contact surface faces away from the fixed contact.

It can be provided that the return spring is a compression spring and that its first end abuts on a contact surface of the bearing plate, which contact surface faces toward the second engagement area.

Preferably, the contact surface faces toward the fixed contact.

It can be provided that

the actuating lever has a first lever arm on which the first engagement area and the second engagement area are formed;

the longitudinal axis of the main spring is parallel to the longitudinal axis of the return spring;

the contact surface of the bearing plate faces toward the main spring.

Preferably, the longitudinal axes are coaxial.

It can be provided that

the actuating lever has a first lever arm on which the first engagement area is formed, and a second lever arm on which the second engagement area is formed, and bent or angled toward the fixed contact and extends relative to the first lever arm at an angle less than 180°;

the longitudinal axis of the main spring extends at that angle relative to the longitudinal axis of the return spring;

the contact surface of the bearing plate faces away from the main spring.

Preferably, the angle is 90°.

It can be provided that each of the proposed actuators comprises

a motion link comprising a sleeve receiving the main spring, the sleeve having a first end and a second end and, fastened to the sleeve, a coupling section having a first coupling surface engaging at or abutting on the first engagement area and a second coupling surface engaging at or abutting on the second engagement area;

where

a first support surface is formed at the first end, which support surface extends inward or toward the inside of the sleeve, and that can abut a second contact surface of the movable contact, which second contact surface faces toward the fixed contact and/or faces away from the first contact surface of the movable contact;

a second support surface is formed at the second end, which second support surface extends inward or toward the inside of the sleeve, and that abuts on the second end of the main spring and/or faces away from the first engagement area.

A movement of the actuating lever can thus be transmitted to the springs and to the movable contact via the motion link.

The sleeve can be formed in any manner as required and can have, for example, an inwardly protruding flange forming the first support surface at its first end.

The sleeve can be formed in any manner as required and can have, for example, an inwardly protruding flange forming the second support surface at its second end, or a wall closing off the end and forming the second support surface.

Preferably, it is provided that

the first coupling surface faces away from the main spring and/or from the movable contact and/or faces toward the first coupling surface and/or the additional spring; and/or

the second coupling surface faces toward the main spring and/or toward the movable contact and/or faces away from the additional spring and/or from the contact surface of the bearing plate.

It can be provided that the actuating lever has a third engagement point or engagement area at which a drive source can engage.

The drive source can be formed in any manner as required and can be, for example, a motor-driven switching shaft and can comprise a cam mechanism with a cam disk fastened to the switching shaft and a cam follower guided at the cam disk, where the cam follower can be coupled to the third engagement area, for example, or the third engagement area can form such a cam follower or can be formed as such a cam follower.

According to a second aspect of the invention, there is proposed a switching assembly comprising

a vacuum switch tube comprising a fixed switch contact or fixed contact and a movable switch contact or movable contact;

an actuator for actuating the vacuum switch tube;

where

the actuator comprises

a bearing plate fastened to the fixed contact;

a main spring having a first end with which it engages at or abuts on the movable contact, and a second end;

an additional spring or return spring having a first end with which it engages at or abuts on the bearing plate, and a second end;

an actuating lever having a first engagement point or engagement area that the main spring engages at or abuts on with its second end, and a second engagement point or engagement area that the return spring engages at or abuts on with its second end, and that can be, in particular, coupled to a drive source;

the actuating lever is pivotably or swivelably mounted on the bearing plate such that the actuating lever can assume a first end position in which the main spring is at least partially, preferably completely, relaxed and the return spring is tensioned and in which, in particular, the movable contact is disconnected from the fixed contact or in which the actuating lever holds the movable contact disconnected from the fixed contact, and a second end position in which the return spring is at least partially, preferably completely, relaxed and the main spring is tensioned and in which the movable contact is pressed against the fixed contact or in which the actuating lever presses the movable contact against the fixed contact.

The proposed switching assembly allows greater contact forces and moreover very easy and compact installation using only few components and involving little wear.

The proposed switching assembly can be, in particular, a switching assembly for an on-load tap changer of a control transformer or of a transformer with adjustable transmission ratio, for example, a load diverter switch for an on-load tap changer of a control transformer.

The proposed switching assembly can be formed in any manner as required and can comprise or have at least one additional or further vacuum switch tube and/or at least one additional or further actuator, for example.

Each actuator can be formed in any manner as required, for example like one of the actuators proposed according to the first aspect.

According to a third aspect of the invention, there is proposed an on-load tap changer comprising

a frame;

a switching assembly;

where

the switching assembly comprises

a vacuum switch tube comprising a fixed switch contact or fixed contact and a movable switch contact or movable contact;

an actuator for actuating the vacuum switch tube;

the actuator comprises

a bearing plate fastened to the fixed contact and to the frame;

a main spring having a first end with which it engages at or abuts on the movable contact, and a second end;

an additional spring or return spring having a first end with which it engages at or abuts on the bearing plate, and a second end;

an actuating lever having a first engagement point or engagement area that the main spring engages at or abuts on with its second end, and a second engagement point or engagement area that the return spring engages at or abuts on with its second end, and that can be, in particular, coupled to a drive source;

the actuating lever is pivotably or swivelably mounted on the bearing plate such that the actuating lever can assume a first end position in which the main spring is at least partially, preferably completely, relaxed and the return spring is tensioned and in which, in particular, the movable contact is disconnected from the fixed contact or in which the actuating lever holds the movable contact disconnected from the fixed contact, and a second end position in which the return spring is at least partially, preferably completely, relaxed and the main spring is tensioned and in which the movable contact is pressed against the fixed contact or in which the actuating lever presses the movable contact against the fixed contact.

The proposed on-load tap changer allows greater contact forces and moreover very easy and compact installation using only few components and involving little wear.

The proposed on-load tap changer can be, in particular, an on-load tap changer for a control transformer or for a transformer with adjustable transmission ratio.

The proposed on-load tap changer can be formed in any manner as required and can comprise or have at least one additional or further frame and/or at least one additional or further switching assembly, for example.

Each switching assembly can be formed in any manner as required, for example like one of the switching assemblies proposed according to the second aspect.

Each actuator can be formed in any manner as required, for example like one of the actuators proposed according to the first aspect.

Preferably, the frame forms the bearing plate or the frame and the bearing plate are in one piece.

It can be provided that each of the proposed on-load tap changers comprises a drive source that engages at or abuts on the third engagement area.

It can be provided that the drive source comprises a switching shaft and a cam mechanism comprising a cam disk non-rotatably connected to the switching shaft, and a cam follower connected to the third engagement area.

It can be provided that the third engagement area forms the cam follower.

The explanations and exemplifications regarding one of the aspects of the invention, in particular regarding individual features of this aspect, also apply correspondingly for the other aspects of the invention.

In the following, embodiments of the invention are explained in detail by means of the attached drawings. The individual features thereof are, however, not limited to the individual embodiments but can be connected and/or combined with individual features described further above and/or with individual features of other embodiments. Each example in the illustrations is provided by way of explanation, not limitation of the invention. The reference characters included in the claims are by no means intended to limit the scope of protection, but rather merely refer to the embodiments shown in the figures, in which

shows a first embodiment of an actuator for actuating a vacuum switch tube, as well as a first embodiment of a switching assembly with such an actuator;

shows a second embodiment of such an actuator, as well as a second embodiment of a switching assembly;

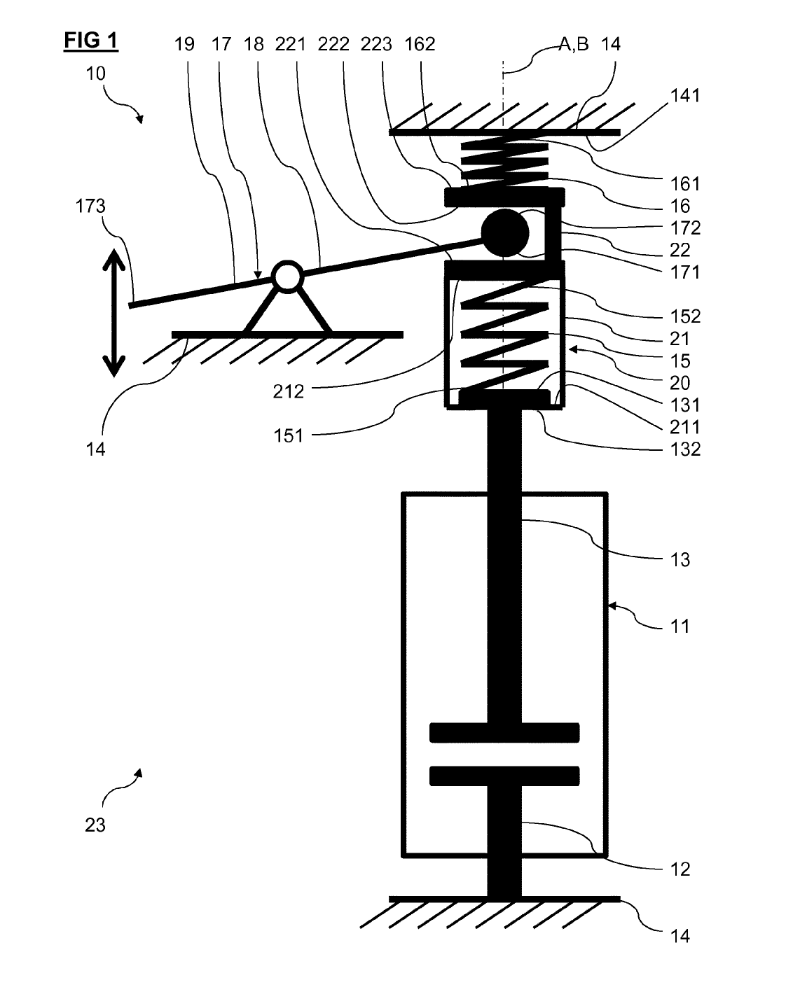

shows the actuator and the switching assembly of FIG. 1 in a first end position, in an intermediate position, and in a second end position;

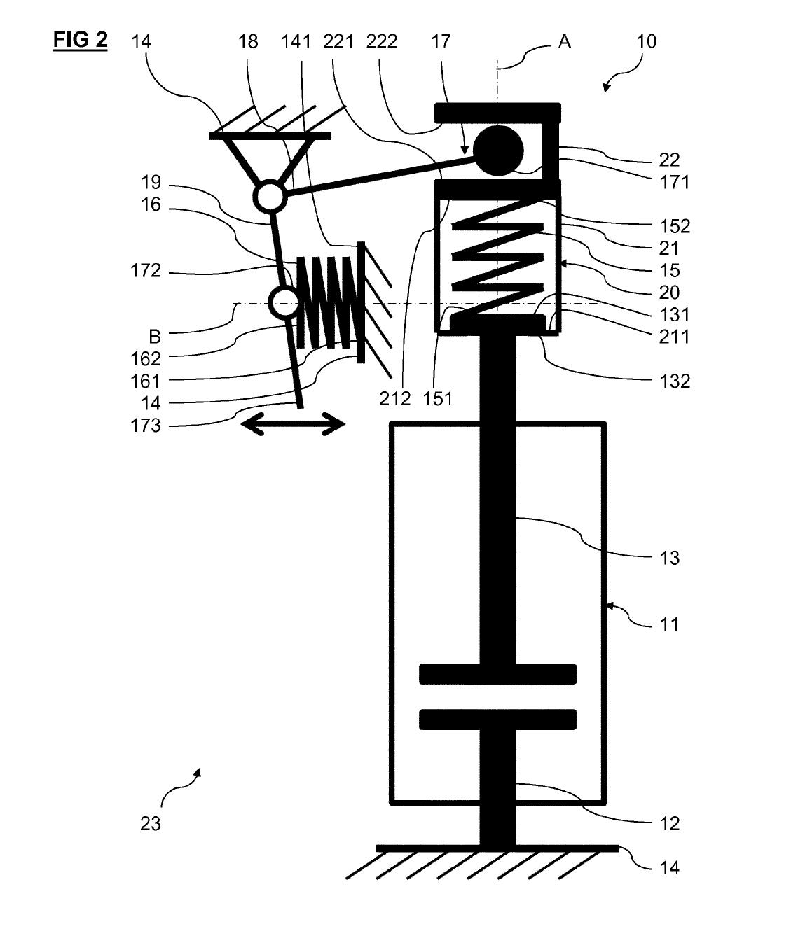

shows the actuator and the switching assembly of FIG. 2 in a first end position, in an intermediate position, and in a second end position;

shows a preferred embodiment of an on-load tap changer with the switching assembly of FIG. 2.

Schematically illustrated in FIG. 1 is a first embodiment of an actuator 10 for actuating a vacuum switch tube 11, as well as a first embodiment of a switching assembly 23.

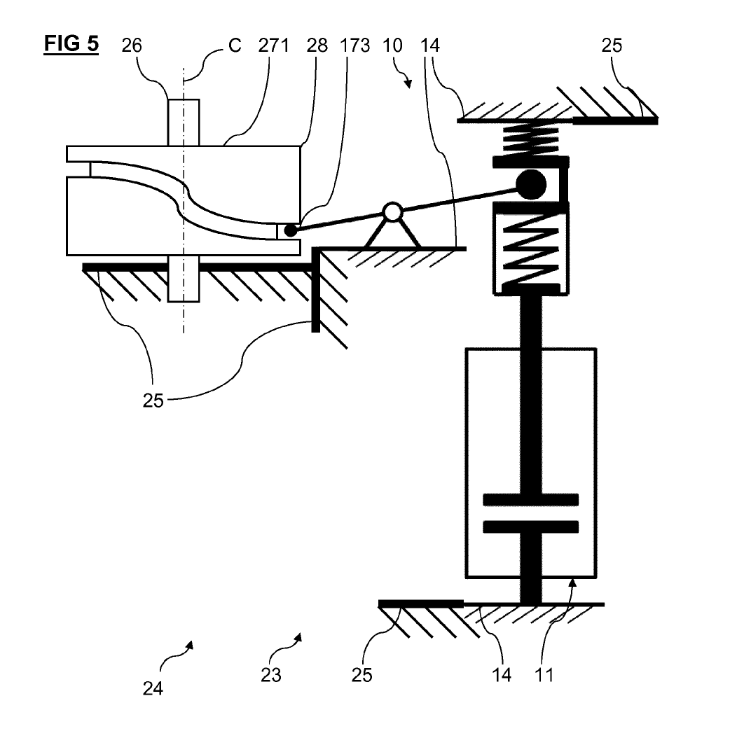

The actuator 10 and/or the vacuum switch tube 11 and/or the switching assembly 23 can be part of an on-load tap changer 24 (FIG. 5), for example. The vacuum switch tube 11 comprises a vacuum housing, a fixed switch contact or fixed contact 12 and a movable switch contact or movable contact 13, for example. Each contact 12, 13 has a plate-shaped contact element positioned in the vacuum housing, and a contact shaft electrically and mechanically connected thereto, guided out of the vacuum housing in a sealed state. The contact shaft of the fixed contact 12 is fastened to the vacuum housing, and the contact shaft of the movable contact 13 is movably mounted on the vacuum housing and formed to be disk-shaped or plate-shaped with a radially outwardly protruding edge at its end positioned distant from the contact element and outside of the vacuum housing.

The switching assembly 23 comprises a vacuum switch tube 11 and an actuator 10 that in this embodiment is exemplarily formed according to the first embodiment.

In this embodiment, the actuator 10 comprises a bearing plate 14 that can be fastened to a frame 25 (FIG. 5) of the on-load tap changer 24, for example, a main spring 15, a return spring 16, an actuating lever 17, and a motion link 20.

The bearing plate 14 can be formed in any manner as required and is here only schematically illustrated in extracts with three sections that are connected to each other in a mechanically rigid manner. The section that is the lower section of the bearing plate 14 in FIG. 1 is fastened to the contact shaft of the fixed contact 12. The actuating lever 17 is swivelably mounted on the section that is the middle or left section of the bearing plate 14 in FIG. 1. A contact surface 141 is formed at the section that is the upper section of the bearing plate 14 in FIG. 1.

In this embodiment, the main spring 15 and the return spring 16 are compression springs and cylindrical coil springs. The main spring 15 has a first end 151 with which it engages at the contact shaft of the movable contact 13, and a second end 152. The return spring 16 has a first end 161 and a second end 162.

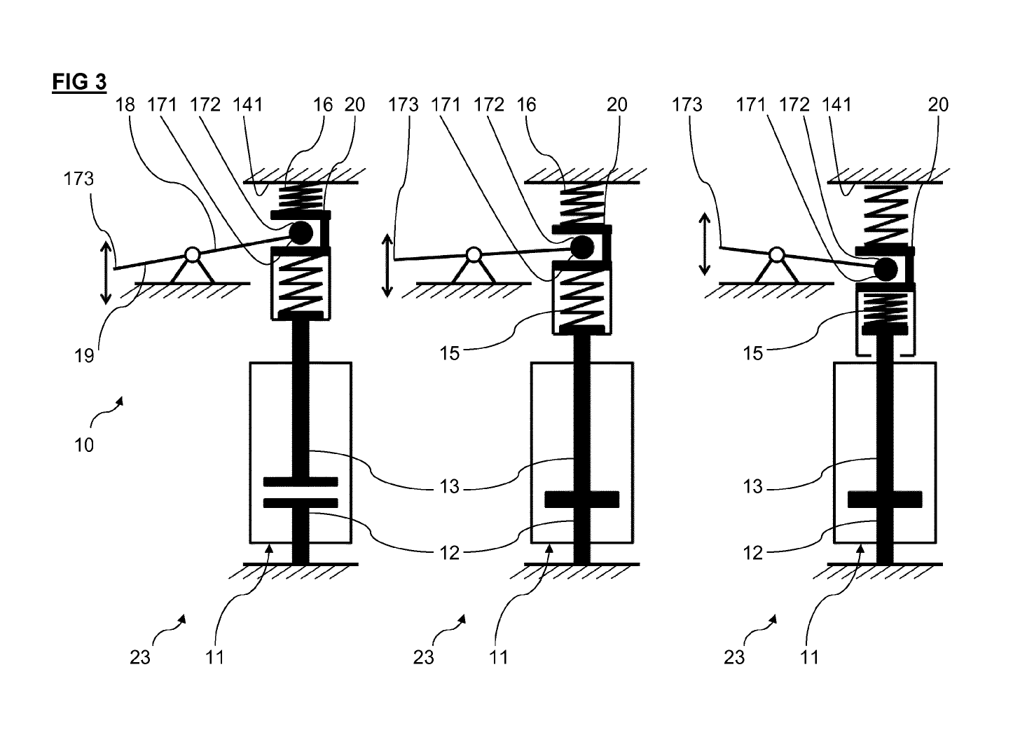

The actuating lever 17 has a first engagement area 171 at which the main spring 15 engages with its second end 152, and a second engagement area 172 at which the return spring 16 engages with its second end 162. The actuating lever 17 is swivelably mounted on the bearing plate 14 such that it can assume a first end position (FIG. 1 and on the left side in FIG. 3), a second end position (on the right side in FIG. 3), and an intermediate position (in the middle in FIG. 3). In the first end position, the main spring 15 is at least partially, preferably completely, relaxed, and the return spring 16 is tensioned, and the movable contact 13 is disconnected from the fixed contact 14. In the second end position, the return spring 16 is at least partially, preferably completely, relaxed, and the main spring 15 is tensioned, and the movable contact 13 is pressed against the fixed contact 14. In the intermediate position, the main spring 15 and the return spring 16 are at least partially, preferably completely, relaxed, and the movable contact touches the fixed contact pressurelessly or forcelessly.

In this embodiment, the main spring 15 and the return spring 16 are formed such that the actuating lever 17 is biased into the first end position. The first end 151 of the main spring 15 abuts on a first contact surface 131 of the movable contact 13, which first contact surface 131 faces toward the first engagement area 171. The first contact surface 131 here is the front face of the disk-shaped end of the contact shaft of the movable contact 13, which front face faces away from the contact elements. The first end 161 of the return spring 16 abuts on and engages at the contact surface 141 of the bearing plate 14. This contact surface 141 here faces toward the second engagement area 172, toward the main spring 15, and toward the movable contact 13.

In this embodiment, the actuating lever 17 is a two-sided, straight lever, and it has a first lever arm 18 and a second lever arm 19 that extends relative to the first lever arm 18 at an angle of 180°. The free end of the first lever arm 18 is here formed to be spherical, and it has the first engagement area 171 at its spherical surface facing toward the main spring 15 and toward the movable contact 13, and the second engagement area 172 at its spherical surface facing away from the return spring 16 and from the movable contact 13. The actuating lever 17 has a third engagement area 173 formed at the free end of the second lever arm 19 and at which a not-illustrated drive source of the on-load tap changer can engage, for example a cam disk driven by a motor and/or by a spring energy storage device.

In this embodiment, the longitudinal axis A of the main spring 15 is parallel, particularly coaxial to the longitudinal axis B of the return spring 16, and the contact surface 141 of the bearing plate 14 faces toward the main spring 15.

The motion link 20 comprises a sleeve 21 receiving the main spring 15, the sleeve 21 having a first end near to the vacuum switch tube 11, and a second end distant from the vacuum switch tube 11, and comprises a coupling section 22 fastened to the second end of the sleeve 21, which coupling section 22 has a first coupling surface 221 engaging at the first engagement area 171, a second coupling surface 222 engaging at the second engagement area 172, and a third coupling surface 223 engaging at the second end 162 of the return spring 16.

At its first end, the sleeve 21 has an inwardly protruding flange that forms an inwardly running, first support surface 211 that abuts on a second contact surface 132 of the movable contact 13, which second contact surface 132 faces toward the fixed contact 12. The second contact surface 132 is the ring-shaped back side of the disk-shaped end of the contact shaft of the movable contact 13, which back side faces is away from the first contact surface 131 and toward the contact elements. At its second end, the sleeve 21 has a wall closing off the end, where the wall, with its inner side facing toward the inside of the sleeve 21, forms an inwardly running second support surface 212 that abuts on the second end 152 of the main spring 15.

The coupling section 22 borders on the second end of the sleeve 21 and directly on the wall of the sleeve 21 such that with its outer side the wall forms the first coupling surface 221 that faces away from the main spring 15. The coupling section 22 has a wall parallel to the wall, and that forms the second coupling surface 222 with the side of the wall that faces toward the sleeve 21 and toward the main spring 15, and that forms the third coupling surface 223 with the oppositely located side of the wall that faces away from the sleeve 21 and from the main spring 15 and that faces toward the return spring 16 and toward the contact surface 141 of the bearing plate 14. The return spring 16 thus engages at the second engagement area 172 of the actuating lever 17 via the wall 222/223 of the coupling section 22 and at the main spring 15 via the motion link 20.

In FIG. 2, a second embodiment of an actuator 10 for actuating a vacuum switch tube 11 and a second embodiment of a switching assembly 23 are schematically illustrated. These second embodiments resemble the first embodiments so that primarily the differences will be explained below.

In this embodiment of the switching assembly 23, the actuator 10 is exemplarily formed according to the second embodiment.

In this embodiment, the actuating lever 17 is an angled lever, where the second lever arm 19 is angled toward the fixed contact 12, that is downward in FIG. 2, and extends relative to the first lever arm 18 at an angle less 90°. The longitudinal axis A of the main spring 15 also extends at an angle of 90° to the longitudinal axis B of the return spring 16. The longitudinal axes A, B and the lever arms 18, 19 lie in the same plane.

The second engagement area 172 is formed on the second lever arm 19 in this embodiment. Compared to the first embodiment, the contact surface 141 of the bearing plate 14 is rotated by 90° and faces away from the main spring 15 and toward the second engagement area 172. With its second end 162, the return spring 16 engages directly at the second engagement area 172, and thus engages at the main spring 15 via the second lever arm 19, via the first lever arm 18, and via the motion link 20.

In FIG. 3, the actuator 10 formed according to the first embodiment and the switching assembly 23 formed according to the first embodiment are schematically illustrated in the first end position, in the intermediate position, and in the second end position.

Shown on the left side is the first end position, in which the third engagement area 173 at the second lever arm 19 is in a bottom dead center, and the first engagement area 171 and the second engagement area 172 at the oppositely located first lever arm 18 are thus in a top dead center. Hereby, the motion link 20 is pulled away from the fixed contact 12 and from the movable contact 13 against the force of the return spring 16, and it is pressed against the contact surface 141 of the bearing plate 14, and the movable contact 13 is pulled away from the fixed contact 12 via the motion link 20. The vacuum switch tube 11 is consequently opened.

Shown in the middle is the intermediate position, in which the third engagement area 173 is in a middle position above its bottom dead center, and the first engagement area 171 and the second engagement area 172 are thus in a middle position below their top dead center. Hereby, the motion link 20 is being held in a middle position against the opposite forces of the return spring 16 and of the main spring 15 that forces at least partially, preferably completely, cancel each other out, and the movable contact 13 and the fixed contact 12 are placed against each other or contacted pressurelessly or forcelessly via the motion link 20. The vacuum switch tube 11 is consequently closed. In this state, however, a too strong current flow would drive the contacts 12, 13 apart.

Shown on the right side is the second end position, in which the third engagement area 173 is in a top dead center, and the first engagement area 171 and the second engagement area 172 are thus in a bottom dead center. Hereby, the motion link 20 is pressed against the movable contact 13 and against the fixed contact 12 against the force of the main spring 15, and it is pulled away from the contact surface 141 of the bearing plate 14, and the movable contact 13 is pressed against the fixed contact 12 via the motion link 20. The vacuum switch tube 11 is consequently closed, and it is also being held closed by the actuator 10 such that even a strong current flow cannot drive the contacts apart.

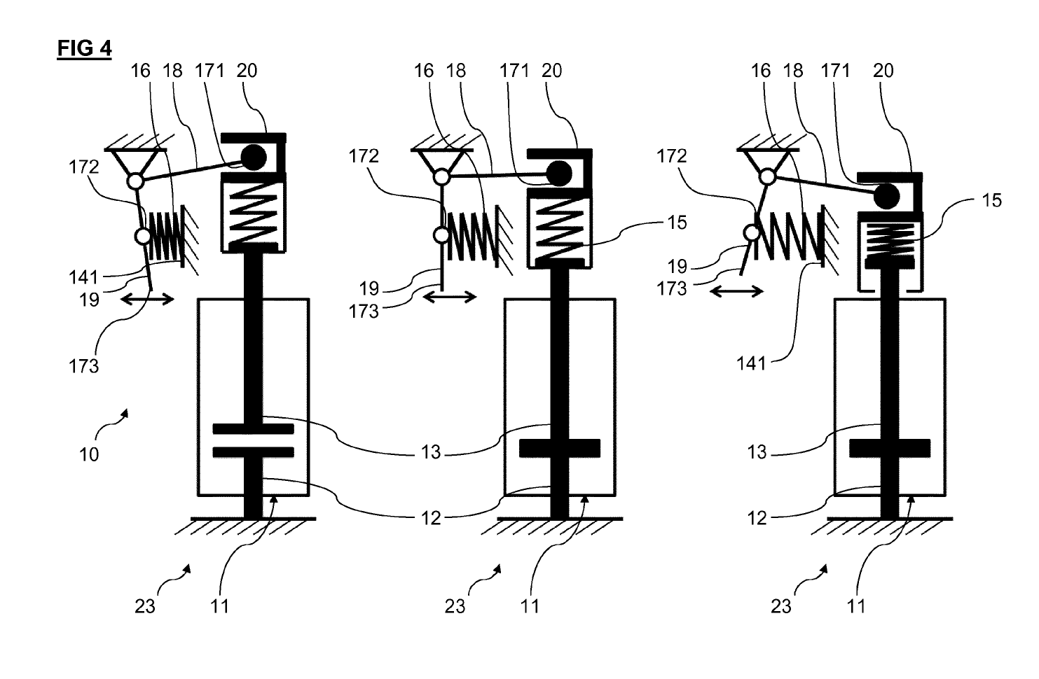

In FIG. 4, the actuator 10 formed according to the second embodiment and the switching assembly 23 formed according to the second embodiment are schematically illustrated in the first end position, in the intermediate position, and in the second end position. This second embodiment resembles the first embodiment so that primarily the differences will be explained below.

Shown on the left side is the first end position, in which the third engagement area 173 at the second lever arm 19 is in a right dead center, and the second engagement area 172 at this second lever arm 19 is thus also in a right dead center, and the first engagement area 171 at the oppositely located first lever arm 18 is thus in its top dead center. Hereby, the second lever arm 19 is pressed against the contact surface 141 of the bearing plate 14 against the force of the return spring 16, and the movable contact 13 is pulled away from the fixed contact 12 via the first lever arm 18 and via the motion link 20. The vacuum switch tube 11 is consequently opened.

Shown in the middle is the intermediate position, in which the third engagement area 173 is in a middle position on the left side of its right dead center, and the second engagement area 172 is thus also in a middle position on the left side of its right dead center, and the first engagement area 171 is thus in its middle position. Hereby, the second lever arm 19 is being held in a middle position against the opposite forces of the return spring 16 and of the main spring 15 that forces at least partially, preferably completely, cancel each other out, and the movable contact 13 and the fixed contact 12 are placed against each other or contacted pressurelessly or forcelessly via the first lever arm 18 and via the motion link 20. The vacuum switch tube 11 is consequently closed. In this state, however, a too great current flow would drive the contacts 12, 13 apart.

Shown on the right side is the second end position, in which the third engagement area 173 is in a left dead center, and the second engagement area 172 is thus also in a left dead center and the first engagement area 171 is thus in its bottom dead center. Hereby, the second lever arm 19 is pulled away from the contact surface 141 of the bearing plate 14 against the force of the main spring 15, and the movable contact 13 is pressed against the fixed contact 12 via the first lever arm 18 and via the motion link 20. The vacuum switch tube 11 is consequently closed, and it is also being held closed by the actuator 10 such that even a great current flow cannot drive the contacts apart.

In FIG. 5, a preferred embodiment of an on-load tap changer 24 is schematically illustrated. The on-load tap changer 24 comprises a frame 25, a switching assembly 23, and a drive source that engages at or is coupled to the third engagement area 173 for the purpose of driving it.

In this embodiment of the on-load tap changer 24, the switching assembly 23 is exemplarily formed according to the second embodiment.

The frame 25 is fastened to the bearing plate 14. The frame 25 can be formed in any manner as required and is here only schematically illustrated in extracts with three sections that are connected to each other in a mechanically rigid manner. The section that is the lower section of the frame 25 in FIG. 5 is fastened to the section that is the lower section of the bearing plate 14 in FIG. 5. The section that is the middle or left section of the frame 25 in FIG. 5 is fastened to the section that is the middle or left section of the bearing plate 14 in FIG. 5. The section that is the upper section of the frame 25 in FIG. 5 is fastened to the section that is the upper section of the bearing plate 14 in FIG. 5.

In this embodiment, the drive source comprises a switching shaft 26 and a cam mechanism comprising a cam disk 27 and a cam follower 28. The switching shaft 26 is mounted on the frame 25 so as to be pivotable about an axis C, and it can be rotated about the axis C by a not-illustrated motor. The cam disk 27 is non-rotatably connected to the switching shaft 26 and in its circumferential surface it has a groove or a cam 271, in which the cam follower 28 is guided. The third engagement area 173 here forms the cam follower 28 such that the cam follower 28 is connected to or coupled to the third engagement area 173.

### REFERENCE SIGNS

10 Actuating device
11 Vacuum switch tube
12 Fixed contact
13 Mobile contact
131/132 First/second contact surface of 13
14 Bearing plate
141 Contact surface of 14
15 Main spring
151/152 First/second end of 15
16 Return spring
161/162 First/second end of 16
17 Actuating lever
171/172/173 First/second/third engagement area of 17
18 First lever arm of 17
19 Second lever arm of 17
20 Motion link
21 Sleeve
211/212 First/second support surface 21
22 Coupling section
221/222/223 First/second/third coupling surface of 22
23 Switching device
24 On-load tap changer
25 Frame
26 Switching shaft
27 Cam disk
271 Curve of 27
28 Cam follower

1. An actuator for actuating a vacuum switch tube, the actuator comprising:
a fixed contact;
a movable contact;
a bearing plate that can be fastened to the fixed contact;
a main spring having a first end with which it can engage the movable contact and a second end;
a return spring having a first end with which it engages at the bearing plate and a second end; and
an actuating lever having a first engagement area at which the main spring engages with its second end, and having a second engagement area at which the return spring engages with its second end, the actuating lever being swivelably mounted on the bearing plate such that the actuating lever can assume a first end position in which the main spring is at least partially relaxed and the return spring is tensioned, and a second end position in which the return spring is at least partially relaxed and the main spring is tensioned.

2. The actuator according to claim 1, wherein the main spring and the return spring are formed such that the actuating lever is biased into the first end position.

3. The actuator according to claim 1, wherein the main spring is a compression spring, and its first end abuts on a first contact surface of the movable contact, which first contact surface faces toward the first engagement area.

4. The actuator according to claim 1 wherein the return spring is a compression spring, and its first end abuts on a contact surface of the bearing plate, which contact surface faces toward the second engagement area.

5. The actuator according to claim 1, wherein
the actuating lever has a first lever arm on which the first engagement area and the second engagement area are formed;
the longitudinal axis of the main spring is parallel to the longitudinal axis of the return spring; and
the contact surface of the bearing plate faces toward the main spring.

6. The actuator according to claim 4, wherein
the actuating lever has a first lever arm on which the first engagement area is formed and a second lever arm on which the second engagement area is formed and that is angled toward the fixed contact and extends relative to the first lever arm at an angle less than 180°;
the longitudinal axis of the main spring extends at the angle relative to the longitudinal axis of the return spring; and
the contact surface of the bearing plate faces away from the main spring.

7. The actuator according to claim 1, further comprising:
a motion link comprising a sleeve receiving the main spring and having a first end and a second end and, fastened to the sleeve, a coupling section having a first coupling surface engaging at the first engagement area and a second coupling surface engaging at the second engagement area;
a first support surface formed at the first end extends inward, and that can abut a second contact surface of the mobile contact, which second contact surface faces toward the fixed contact;
a second support surface formed at the second end, extends inward and abuts on the second end of the main spring, the first coupling surface being directed away from the main spring, the second coupling surface being directed toward the main spring.

8. The actuator according to claim 1, wherein the actuating lever has a third engagement area engageable with a drive source.

9. A switch assembly comprising:
a vacuum switch tube comprising a fixed contact and a mobile contact;
an actuator for actuating the vacuum switch tube and comprising:
a bearing plate fastened to the fixed contact;
a main spring having a first end with which it engages at the movable contact and a second end;
a return spring having a first end with which it engages at the bearing plate and a second end;
an actuating lever having a first engagement area at which the main spring engages with its second end, and having a second engagement area at which the return spring engages with its second end; and
the actuating lever is swivelably mounted on the bearing plate such that the actuating lever can assume a first end position in which the main spring is at least partially relaxed and the return spring is tensioned and in which, in particular, the movable contact is disconnected from the fixed contact, and a second end position in which the return spring is at least partially relaxed and the main spring is tensioned and in which, in particular, the movable contact is pressed against the fixed contact.

10. An on-load tap changer comprising:
a frame
a switch assembly comprising:
a vacuum switch tube comprising
a fixed contact and
a movable contact; and
an actuator for actuating the vacuum switch tube and comprising:
a bearing plate fastened to the fixed contact and to the frame;
a main spring having a first end with which it engages at the movable contact and a second end;
a return spring having a first end with which it engages at the bearing plate and a second end;
an actuating lever having a first engagement area at which the main spring engages with its second end and a second engagement area at which the return spring engages with its second end the actuating lever being swivelably mounted on the bearing plate such that the actuating lever can assume a first end position in which the main spring is at least partially relaxed and the return spring is tensioned and in which, in particular, the movable contact is disconnected from the fixed contact, and a second end position in which the return spring is at least partially relaxed and the main spring is tensioned and in which the movable contact is pressed against the fixed contact.

11. The on-load tap changer according to claim 10, further comprising:
a drive source that engages at the third engagement area.

12. The on-load tap changer according to claim 11, wherein the drive source comprises:
a switching shaft and
a cam mechanism that comprises a cam disk nonrotatably connected to the switching shaft, and a cam follower connected to the third engagement area.

13. The on-load tap changer according to claim 12, wherein the third engagement area forms the cam follower.
